(19) United States
(12) Patent Application Publication
(10) Pub. No.: US 2007/0053257 A1
(43) Pub. Date: Mar. 8, 2007

(54) Method of controlling optical disc device

(76) Inventor: Ryouichi Ishikawa, Kyoto (JP)

Correspondence Address: MCDERMOTT WILL & EMERY LLP, 600 13TH STREET, N.W., WASHINGTON, DC, 20005-3096, US

(21) Appl. No.: 11/514,988

(22) Filed: Sep. 5, 2006

(30) Foreign Application Priority Data
Sep. 5, 2005 (JP) 2005-256580

(51) Int. Cl. G11B 7/00

(52) U.S. Cl. 369/44.32; 369/53.14

(57) ABSTRACT

In an optical disc device according to the present invention, a vibration detecting band of a vibration detector for detecting variations in the optical disc device is set to a band capable of selectively detecting the vibration generated in the optical disc device when it is detected that an optical disc mounted in the optical disc device so as to be rotated and driven has eccentricity, and the vibrations are detected by the vibration detector in the state where the optical disc is rotated in the optical disc device so that the optical disc in the rotating state is judged to be eccentric in response to the detection of the vibrations.

### BACKGROUND OF THE INVENTION

1. Field of the Invention

The present invention relates to a method of controlling an optical disc device in order to better reproduce an eccentric disc without undermining an ability for reproducing a scratch disc in an optical disc device such as a CD (Compact Disc: trade name) player and a DVD (Digital Versatile Disc: trade name) player.

2. Description of the Related Art

In recent years, in an optical disc device such as a CD player, it has been an important item to improve a reproducing ability of an optical disc in order to differentiate a product against other manufacturer's ones. In general, two terms of a scratch disc and an eccentric disc are the key factors for defining the reproducing capacity of the optical disc.

The scratch disc refers to an optical disc on which scratches are generated. It is given a higher evaluation for its reproduction performance to such a CD player that can more smoothly reproduce data without any problem even if a scratch having a long physical length is present on the scratch disc. The eccentric disc is an optical disc in which a center position is shifted.

It is better that a servo gain is reduced in order to improve the reproducing capacity of the scratch disc, while the servo gain is increased in order to improve the reproducing capacity of the eccentric disc. When the servo gain is increased or reduced, the reproducing capacity of the scratch disc and the eccentric disc can be adjusted. However, the adjustment is difficult because it is under the relationship that the reproducing capacity for one among the scratch disc and the eccentric disc is improved, the reproducing capacity for the other is deteriorated.

FIG. 6 is a block diagram showing a conventional optical disc device. Referring to reference numerals shown in FIG. 6, 61 denotes an optical disc, 62 denotes a spindle motor, 63 denotes a pickup, 64 denotes a head amplifier, 65 denotes a servo control chip, 66 denotes a servo filter, 67 denotes a vibration detector, 68 denotes a tracking error signal (hereinafter, referred to as TE signal), 69 denotes a driver, and 70 denotes a microcomputer for control. The vibration detector 67 detects vibrations using a digital filter (band pass filter) which allows only signal in a predetermined frequency band to pass through.

The spindle motor 62 rotates the optical disc 61. The pickup 63 reads the signals from the optical disc 61. The head amplifier 64 amplifies the signals from the pickup 63. The TE signal 68 is information showing a position shift of the pickup 63 generated in the head amplifier 64. The servo control chip 65 executes an operation of the servo control based on the TE signal 68 from the head amplifier 64. The servo filter 66 executes the servo operation in the servo control chip 65. The vibration detector 67 detects a vibration component in the TE signal 68 in the servo control chip 65. The driver 69 amplifies a signal outputted from the servo control chip 65, and drives the pickup 63 to a targeted point of the optical disc 61 based on the amplified signal. The microcomputer 70 for control controls each part described above.

Next, a method of detecting the vibrations in the optical disc is described. Before the vibration detector 67 was installed in the device, an analog filter (band pass filter) comprising resistances and capacitances was conventionally provided outside the circuit. The analog filter detects a signal component superposed on the TE signal when the vibration is applied to the optical disc device from outside thereby to detect the vibrations. When the vibration is thus detected, the tracking servo may be deviated. Therefore, a gain of the servo is increased so that the deviation of the tracking servo is prevented.

The deviation of the tracking servo means that the tracking servo cannot be maintained. When the tracking servo is deviated, a laser spot is unable to follow suit along pits, which interrupts the acquisition of data. As a result, problems such as sound jump may be thereby caused.

In the constitution described above, it increases costs to require the external analog filter. As an approach adopted in recent years in order to reduce the costs of the entire set, the vibration detector 67 having the digital filter is included in the servo control chip 65 as shown in FIG. 6 so that the external analog filter is omitted. This structure requires a function capable of changing a pass band (defined based on first and second cut-off frequencies) of the digital filter included in the vibration detector 67 for each client. Therefore, the pass band of the built-in vibration detector 67 can be changed in the servo control chip 65.

Megatrend in the optical disc device thus improved, particularly in an in-vehicle CD player, was conventionally an optical disc device provided with three motors such as a spindle motor, a thread motor and a loading motor, (hereinafter, referred to as three-motor optical disc device). In order to further promote the cost reduction, an optical disc device is appearing in recent years wherein one of the motors is omitted in such a manner that the thread motor and the loading motor are used by switching with a gear (hereinafter, referred to as two-motor optical disc device). The one of the motors is reduced so that the costs for the optical disc device can be further lowered.

The thread motor is a motor which moves the pickup 63 along a radial direction of the optical disc 61, and controlled by the servo control chip 65 via a thread motor driver. The loading motor is a motor for moving a disc tray on which the optical disc 61 is mounted, and controlled by the microcomputer 70 via a loading motor driver. In the improvement described above, a driving source of the optical disc device consists of the two motors of the spindle motor and the thread-and-loading motor by using one motor as both the thread motor and the loading motor.

However, in the structure of the two-motor optical disc device, number of the gears to be provided between the motors and threads is increased because the switchover of the gear becomes necessary, and thereby allowance is accumulated that is generated in the respective engagements of the gears when the thread motor is controlled. As a result, a thread movement number due to a cogging of the motors (choppy motion resulting from the structural characteristics of the motors is not stabilized and thereby variation of the thread movement number per cogging is larger in the two-motor optical disc device than in the three-motor optical disc device Therefore, it becomes necessary to further increase the servo gain in the two-motor optical disc device for reproduction of the eccentric disc in consideration of the variation of the thread movement number.

In view of the features described above, it was possible to set a gain so that the scratch disc and the eccentric disc can be both reproduced in the three-motor optical disc device, while it becomes impossible to improve the capacity for reproducing the scratch disc if the servo gain is further increased in order to improve the capacity for reproducing the eccentric disc including the variation of the thread movement number in the two-motor optical disc device. Therefore, it is impossible to set the gain value at one point so as to be able to achieve a better reproduction capability for the both discs in the two-motor optical disc device.

As described above, the reproduction capacity of the two-motor optical disc device, which was designed to reduce the costs, was actually worsened in performance because it cannot attain that of the three-motor optical disc device.

### SUMMARY OF THE INVENTION

Therefore, a main object of the present invention is to attain the reproduction capacity equal to that of the three-motor optical disc device in the inexpensive two-motor optical disc device by discriminating the eccentric disc and any disc other than the eccentric disc using the vibration detector and setting the servo gain to a relatively high value in the case where the relevant disc is detected as the eccentric disc.

In order to achieve the foregoing object, a method of controlling an optical disc device according to the present invention is a method of controlling an optical disc device having a vibration detector for detecting vibrations, comprising:

a setting step in which a detected vibration band of the vibration detector is set to a band capable of selectively detecting the vibrations generated in the optical disc device in the case where an optical disc mounted in the optical disc device and being rotated therein has eccentricity; and

a judging step in which the vibration is detected by the vibration detector in the state where the optical disc is rotated in the optical disc device after the detected vibration band is set in the setting step, and it is judged that the optical disc in the rotating state is eccentric when the vibration is detected.

According to the foregoing constitution, it can be judged that the driven optical disc is eccentric when the vibration detector detects the vibrations in the state where the disc is rotated. The method of controlling the optical disc device according to the present invention further includes a step in which a constant of a servo filter for controlling the rotation of the disc in the optical disc device is changed into a servo constant for the eccentric disc when it is judged that the optical disc in the rotating state is eccentric in the judging step.

A driving rotation number of the optical disc in the optical disc device can be used as a frequency of the vibrations generated in the case where the optical disc is eccentric.

According to the method of controlling the optical disc device according to the present invention, the detected vibration band of the vibration detector is set to the band capable of selectively detecting the vibrations generated in the optical disc device in the case where the optical disc mounted in the optical disc device and under the rotating state is eccentric for each optical disc subjected to the reproduction, and then, it is judged whether or not the optical disc in the eccentric disc. When it is determined that the optical disc is the eccentric disc based on the judgment, the servo constant (servo gain) is changed into the servo constant for the eccentric disc. Accordingly, the capacities for reproducing the scratch disc and the eccentric disc can be both improved, which was conventionally difficult in the inexpensive two-motor optical disc device.

As the vibration detector, a vibration detector comprising a filter for selectively allowing passage of a frequency component superposed on a recording/reproduction position control signal of the optical disc device by the vibrations, may be used.

Further, as the filter, a digital filter, capable of switching a first filter characteristic which selectively allows the passage of the frequency component superposed on the recording/reproduction position control signal in the state where the vibration is generated in the optical disc device and a second filter characteristic which selectively allows the passage of the frequency component superposed on the recording/reproduction position control signal in the state where the eccentric optical disc is rotated and driven, may be used. Accordingly, a filter characteristic of the digital filter can be changed from the first filter characteristic to the second filter characteristic in the setting step.

Further, as the recording/reproduction position control signal, for example, a tracking error signal may be used.

It is preferable that the vibration is preferably detected by the vibration detector in a state where an amplitude gain of the recording/reproduction position control signal is adjusted so that variation difference due to the optical disc and the pickup are reduced in the judging step. The eccentric disc can be thereby more accurately detected.

Further, it is preferable that the judging step is executed when TOC is read, and at the same time output number of times of the frequency component outputted from the filter is measured, and the optical disc in the rotating and driving state is judged to be eccentric in the case where the output number is at least a predetermined number in the judging step. More specifically, in the judging step, a time length of a period when the TOC is read is measured, the output number of times of the frequency component outputted from the fitter during the TOC reading period is measured, and the output number is divided by the time length of the TOC reading period so that the output number per unit time is calculated, and it is judged that the optical disc in the rotating and driving state is eccentric when the calculated output number per unit time is approximate to the rotation number of the optical disc in the optical disc device.

In the case where the output number per unit time calculated by dividing the output number of the filter by the time length of the TOC reading period is substantially equal to the rotation number of the optical disc, the driven optical disc is judged to be eccentric, so that it can be prevented that any optical disc which is not eccentric is misjudged as the eccentric disc. As a result, the eccentric disc can be more accurately detected.

An optical disc device according to the present invention comprises:

a spindle motor for rotating an optical disc retained on a disc tray;

a pickup for recording and reproducing data of the rotated optical disc;

a head amplifier for amplifying an output of the pickup and generating a tracking error signal based on the output of the pickup;

a servo controller for executing a servo operation based on the tracking error signal;

a driver for moving the pickup to a targeted point of the optical disc based on a result of the operation by the servo controller; and

a controller for controlling these components, wherein

the servo controller comprises a vibration detector,

the vibration controller comprises a digital filter capable of switching a first filter characteristic which selectively allows passage of a frequency component: superposed on the tracking error signal when vibration is generated and a second filter characteristic which selectively allows the passage of the frequency component superposed on the tracking error signal when the optical disc having eccentricity is rotated and driven,

the controller sets a filter characteristic of the digital filter to the first filter characteristic when the vibration is detected and sets the filter characteristic to the second filter characteristic when the eccentricity of the optical disc is detected, and

the vibration detector detects the vibrations in the device or the eccentricity of the disc depending on with or without the passed output from the digital filter.

It is preferable that the controller makes the vibration detector detect presence or absence of the eccentricity of the optical disc every time when the optical disc is mounted in the optical disc device.

The optical disc device preferably further comprises a motor for reciprocating the disc tray between a recording/reproduction position and a disc removal position and moving the pickup along a radial direction of the optical disc based on the control by the driver. The controller preferably sets a servo constant of the servo controller to a servo constant for the eccentric disc when the vibration detector detects the eccentricity of the optical disc, and sets the servo constant to a servo constant for the non-eccentric disc otherwise.

According to the optical disc device thus constituted, the detected vibration band of the vibration detector is set to the band capable of selectively detecting the vibrations generated in the optical disc device in the case where the optical disc mounted in the optical disc device and under the rotating and driving state is eccentric for each optical disc subjected to the reproduction, and then, it is judged whether or not the optical disc is the eccentric disc. In the case where the judging result indicates the eccentric disc, the servo constant (servo gain) is changed into the gain for the eccentric disc. As a result, the capacities for reproducing the scratch disc and the eccentric disc can be both improved, which was conventionally difficult in the inexpensive two-motor optical disc device.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention

FIG. 1 is a block diagram of an optical disc device according to a preferred embodiment of the present invention.

FIG. 2 shows a structure of a vibration detector according to the preferred embodiment.

FIG. 3 is a filter characteristic diagram of a vibration detection filter according to the preferred embodiment.

FIG. 4 is a flowchart of a method of controlling the optical disc device according to the preferred embodiment.

FIG. 5 is a characteristic chart showing a VDET signal according to a modified embodiment of the preferred embodiment.

FIG. 6 is a block diagram of a conventional optical disc device.

### DETAILED DESCRIPTION OF THE INVENTION

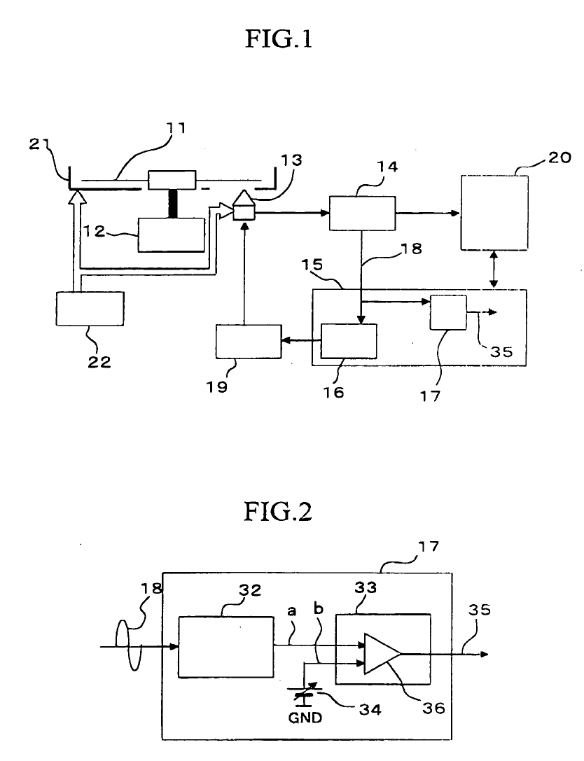

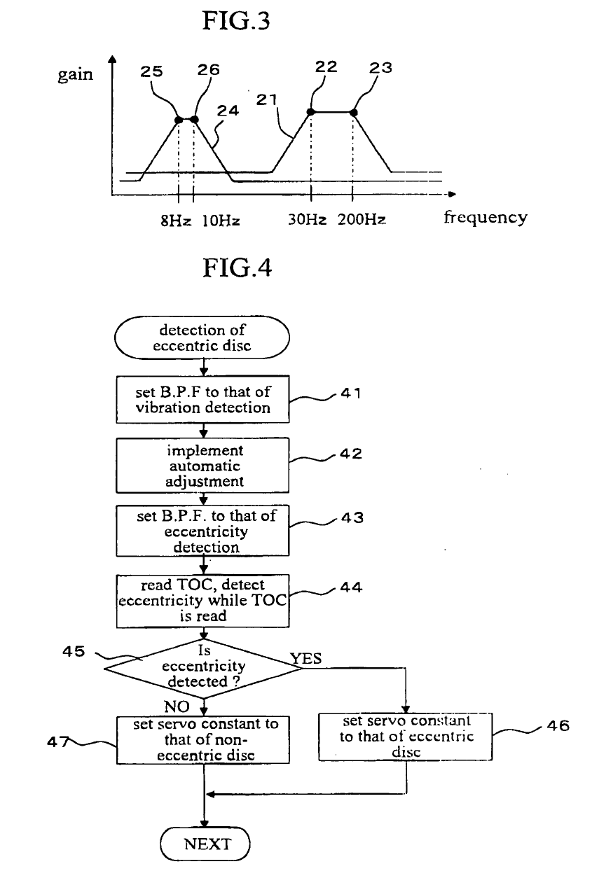

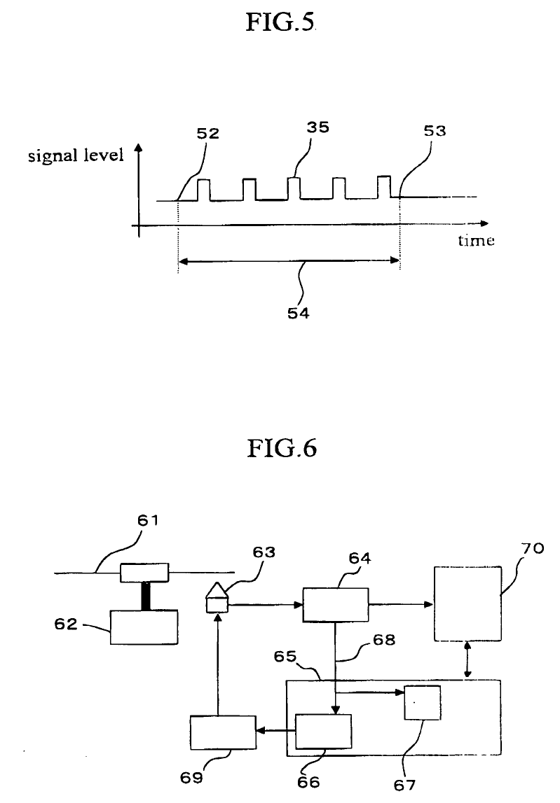

Hereinafter, a preferred embodiment of the present invention is described referring to the drawings. FIG. 1 is a block diagram of an optical disc device. FIG. 2 shows a structure of a vibration detector. FIG. 3 is a characteristic diagram of a vibration detection filter. FIG. 4 is a flow chart of a method of controlling the optical disc device

With respect to reference numerals shown in FIG. 1, 11 denotes an optical disc, 12 denotes a spindle motor, 13 denotes a pickup, 14 denotes a head amplifier, 15 denotes a servo control chip, 16 denotes a servo filter, 17 denotes a vibration detector, 18 denotes a TE signal, 19 denotes a driver, 20 denotes a microcomputer for control, 21 denotes a disc tray, and 22 denotes a motor. The spindle motor 12 rotates the optical disc 11. The pickup 13 reads the signals from the optical disc 11. The head amplifier 14 amplifies the signals from the pickup 13. The TE signal 18 is an information showing a position shift of the pickup 13 generated in the head amplifier 14. The servo control chip 15 executes an operation of the servo control based on the TE signal 18 from the head amplifier 14. The servo filter 16 executes an operation of the servo in the servo control chip 15. The vibration detector 17 detects vibrations based on the TE signal 18 in the servo control chip 15. The disc tray 21 receives the optical disc 11. The motor 22 reciprocates the disc tray 21 between a recording/reproduction position and a disc removal position and makes the pickup 13 move along a radial direction of the optical disc 11.

The vibrations recited in the present invention mean the vibrations generated in the optical disc device due to various factors. The vibration detector 17 is incorporated in the optical disc device in order to detect the vibrations. The present invention is characterized in that the vibration detector 17 is diverted to further detect eccentricity of the optical disc 11. In order for the vibration detector 17 to exert such a function, the vibration detector 17 has a detected vibration band for detecting the vibrations specifically generated due to the eccentricity of the disc other than a detected vibration band for detecting the vibrations originally generated.

The driver 19 amplifies signals outputted from the servo control chip 15, and drives the pickup 13 to a targeted point of the optical disc 11 based on the amplified signals. The microcomputer 20 is an example of a controller for controlling the foregoing components.

FIG. 2 shows an example of a structure of the vibration detector 17. With respect to reference numerals shown in FIG. 2, 18 denotes a TE signal, 32 denotes a vibration detection filter, 33 denotes a level comparator, 34 denotes a threshold value setting device, 35 denotes a VDET signal, and 36 denotes an operational amplifier constituting the level comparator 33. A digital filter (band pass filter) constitutes the vibration detection filter 32. The digital filter (band pass filter) is a filter having such a filter characteristic that allows only signals in a predetermined frequency band to pass through. The vibration detection filter 32 has a eccentricity detecting filter characteristic (second filter characteristic) other than an original vibration detection filter characteristic (first filter characteristic) for detecting the vibrations generated in the optical disc device, wherein these two filter characteristics is constituted so as to be able to switch to each other. The level comparator 33 compares an output a of the vibration detection filter 32 and a threshold output b outputted from the threshold value setting device 34 to each other using the operational amplifier 36, and selectively outputs the VDET signal 35 which is “High” under the conditions of (the output a>threshold output b). The threshold output b is set to a value slightly smaller than a gain ordinarily acquired by a filter pass band component of the TE signal 18 passed through the vibration detection filter 32. The level comparator 36 supplied with the threshold output b which is set to such a value selectively outputs the VDET signal 35 which is “High” during a period when the signals in the pass band are outputted from the vibration detection filter 32.

FIG. 3 is a filter characteristic diagram of the vibration detection filter 32. With respect to reference numerals shown in FIG. 3, 21 denotes a characteristic curve of the vibration detection filter characteristic (first filter characteristic), 24 denotes a characteristic curve of the eccentricity detecting filter characteristic (second filter characteristic), 22 denotes a first cut-off frequency in the vibration detection filter characteristic 21, 23 denotes a second cut-off frequency in the vibration detection filter characteristic 21, 25 denotes a first cut-off frequency in the eccentricity detecting filter characteristic 24, and 26 denotes a second cut-off frequency in the eccentricity detecting filter characteristic 24. The eccentricity detecting filter characteristic 24 has such a characteristic that uses a band (8-10 Hz) in which both ends are defined by the cut-off frequency as the pass band and attenuates or blocks any other band. The vibration detection filter characteristic 21 has such a characteristic that uses a band (30-200 Hz) in which both ends are defined by the cut-off frequency as the pass band and attenuates or blocks any other band. The vibration detection filter characteristic has such a characteristic that selectively allows the passage of the frequency, component superposed on the tracking error signal in the state where the vibration is generated in the optical disc device. The eccentricity detection filter characteristic has such a characteristic that selectively allows the passage of the frequency component superposed on the tracking error signal in the state where the optical disc device is rotated and driven.

The VDET is an abbreviation of Vibration Detection, and generally denotes the vibration detection. Describing the VDET recited in the present preferred embodiment, the signal outputted from the vibration detector 17 when the application of the vibrations to the optical disc device or the presence of the eccentricity in the optical disc 11 is detected is called the VDET signal 35. When the vibration is applied to the optical disc device or the eccentric disc is reproduced, a low vibration component of a substantially determined frequency is superposed on the TE signal 18. As an example, the low vibration component of approximately 30 Hz-200 Hz is superposed on the TE signal 18 when the vibration is applied to the optical disc device, while the low vibration component of approximately 8 Hz is superposed on the TE signal 18 when the eccentric disc is reproduced at a normal speed. The frequency of the low vibration component superposed on the TE signal 18 when the eccentric disc is reproduced is defined as follows.

The vibrations generated in the optical disc device at the time of the rotation of the eccentric disc result from the rotation of the eccentric disc, and the vibration frequency of the vibrations is equal to a rotation frequency in an inner peripheral part of the disc. A rotation speed in the inner peripheral part of the optical disc 11 when the optical disc is rotated and driven at the normal speed is approximately 8 Hz. Therefore, the low vibration component superposed on the TE signal 18 when the eccentric disc is reproduced is determined as approximately 8 Hz. By switching the filter characteristic of the vibration detection filter 32 to the vibration detection filter characteristic 21 (approximately 30 Hz-200 Hz), the eccentricity is not any more detected, however, the vibrations can be detected. Therefore, when the vibration is generated in the optical disc device in the foregoing state, the generated vibration is detected by the vibration detector 17, and the VDET signal 35 showing the detection of the vibrations is outputted correspondingly from the vibration detector 17. Furthermore, by switching the filter characteristic of the vibration detection filter 32 to the eccentricity detecting filter characteristic 24 (approximately 8 Hz-10 Hz), the vibration is not any more detected but the eccentricity can be detected. Therefore, when the optical disc 11 having the eccentricity is mounted in the optical disc device and rotated under driving in the foregoing state, the vibration detector 17 detects the eccentricity of the optical disc 11, and the VDET signal 35 showing the detection of the eccentricity is correspondingly outputted from the vibration detector 17.

In order to detect the eccentric disc, it is necessary for the optical disc to be rotated and driven at a regulated rotation speed such as the normal speed (8 Hz) in a state where focus servo, tracking servo and spindle servo are normally functioning. It is due to the reason described below.

The eccentricity detecting filter characteristic 24 previously set in the vibration detection filter 17 is set on the assumption of detecting the eccentricity in the state where the optical disc 11 is rotated and driven at such a regulated rotation speed as the normal speed. Therefore, it becomes not possible to detect the eccentricity of the optical disc 11 when the optical disc is rotated and driven at any rotation speed other than the regulated rotation speed.

Further, it is necessary to detect the eccentric disc without increasing a time length required for initialization including automatic adjustment before the reproduction of the disc because any additional step for detecting the eccentric disc consequently increases a time length required or starting the sound reproduction from the mounted optical disc 11. In recent years, there is such a strong demand from customers that the time length for the sound reproduction from the optical disc 11 is desirably reduced by even 100 ms. It is not acceptable that the time length required for the initialization including the automatic adjustment be increased in order to detect the eccentric disc. In the automatic adjustment, individual variations in the respective optical disc devices are absorbed so that any possible variation in performances between the devices can be eliminated. The adjustment was conventionally implemented in the manufacturing process, however, as a recent trend, LSI installed in the optical device (including the microcomputer 20 for control) executes the adjustment together with the initialization as a pre-processing for the reproduction. More specifically, the automatic adjustment means that offset of the amplifier is removed, variation of the gain is controlled, or the like.

In order to control the increase of the initialization time, the filter characteristic of the vibration detection filter 32 is changed from the vibration detection filter characteristic 21 to the eccentricity detecting filter characteristic 24 before TOC is read, and then, the TOC is read. Accordingly, operation for reading the TOC and detecting the eccentricity is carried out at the same time so that the increase of the initialization time can be prevented.

The TOC is an abbreviation of Table of Contents, which is an information showing where each of music recorded in the optical disc starts. The TOC is recorded at an inner end of the disc and read during the initialization before the reproduction of the optical disc.

When the microcomputer 20 for control detects that the vibration detector 17 outputs the VDET signal 35 which is level “High” while the TOC is read or after the TOC is read, that is, in a period during which the TOC is read and the tracking servo operation is executed, the microcomputer 20 judges that the optical disc 11 being currently reproduced is the eccentric disc, and sets the servo constant to the servo constant for the eccentric disc in which the gain is increased.

A control flow of the optical disc device is specifically described referring to FIG. 4. FIG. 4 is a flow chart illustrating the eccentric disc detecting process in the method of controlling the optical disc device. When the initialization is commenced, the filter characteristic of the vibration detection filter 32 is set to the vibration detection filter characteristic 24 (Step 41). The automatic adjustment is executed in this state (Step 42). Next, the filter characteristic of the vibration detection filter 32 is changed from the vibration detection filter characteristic 24 to the eccentricity detecting filter characteristic 21 as the pre-processing of the TOC reading operation executed during the automatic adjustment (Step 43). Then, the TOC is read. At the same time as the TOC reading operation, the vibration detector 17 detects the eccentric disc (Steps 44 and 45).

The microcomputer 20 for control, which detected that the VDET signal 35 outputted from the vibration detector 17 is at the “High” level in the Step 45, judges that the optical disc 11 to which the pre-processing of the reproduction is being executed is the eccentric disc, and proceeds to Step 46. In the Step 46, the microcomputer 20 for control calculates the servo constant for the eccentricity in which the gain is increased as the servo constant in accordance with the optical disc 11 detected as the eccentric disc, and sets the calculated servo constant in the head amplifier 14.

The microcomputer 20 for control, which detected that the VDET signal 35 outputted from the vibration detector 17 is at the “Low” level in the Step 45, judges that the optical disc 11 to which the pre-processing of the reproduction is executed, is the disc with no eccentricity, and proceeds to Step 47. In the Step 47, the microcomputer 20 for control calculates the servo constant for the normal disc as the servo constant in accordance with the optical disc 11 detected as the normal disc, and sets the calculated servo constant in the head amplifier 14.

According to the method of controlling the optical disc device and the optical device thus constituted, the filter characteristic of the vibration detection filter 17 is appropriately switched by the microcomputer 20 for control so that the detection of the eccentric disc, which was difficult in the conventional technology, can be realized.

According to this the servo constant suitable for the eccentric disc can be set when the eccentric disc is detected. Further, the performance of the two-motor optical disc in which the thread movement number is variable can be equal to that of the three-motor optical disc device in terms of the compatibility of reproducing the scratch disc and the eccentric disc.

As the above description, in the present preferred embodiment, the performance of the optical disc device in reproducing the disc can be improved while the cost reduction is realized at the same time.

Immediately before the TOC is read, the filter characteristic of the vibration detection filter 32 is changed from the vibration detection filter characteristic 21 to the eccentricity detecting filter characteristic 24. Therefore, the eccentric disc can be detected without the increase the time length required for the initialization including the automatic adjustment.

A modified embodiment of the present preferred embodiment is shown below. In recent years, the optical discs 11 of various types, such as CD-R (Compact Disc Recordable: trade name), high reflectivity/low reflectivity CD-RW (Compact Disc Rewritable: trade name) and the like, other than CD-DA (Compact Disc Digital Audio: trade name) are arrived on the market. Further, the pickup 13 whose performance is largely variable is often incorporated into the optical disc device in order to further reduce the costs.

In order to maintain the reproduction capacity at a certain level under these circumstances, the servo control chip 15 which was recently developed comprises a function capable of adjusting the gain (amplitude) of an FE signal/TE signal in multiple steps. The FE signal is an abbreviation for a focus error signal, and more specifically is a signal showing whether or not a laser spot in a focus direction maintain a local point.

The foregoing function is used so that the amplitude of the FE signal /TE signal is measured during the initialization, and the multiple-step gain in the head amplifier 14 is adjusted based on a result of the measurement so that the FE signal /TE signal with a given amplitude is outputted. Thereby, the FE signal /TE signal whose amplitude was adjusted to the substantially given level is supplied to the servo control chip 15. The rest of the constitution other than the function is similar to those shown in FIGS. 1-4.

In the conventional head amplifier, there were only a few steps for the switchover of the FE signal/TE signal amplitude. More specifically, the switchover was limitedly to normal speed or four-time speed. For example, the normal speed was adopted in the CD-DA, while the four-time speed was adopted in the CD-RW. However, the optical discs and pickups in which the various FE/TE signals are used are now commercialized in the market, which is making it increasingly difficult to secure a sufficient performance in the switchover of a few steps. However, when the amplitude of the very FE signal/TE signal is variable depending on the reflectivity of the pickup or the optical disc, there causes a state that the vibrations or the eccentricity can be normally detected in one combination but not be detected in the other one.

In the multiple-step gain (amplitude) control in the head amplifier 14 that was described earlier, the gain is unlimitedly adjusted literally in multiple steps so that the detection can be more efficiently realized. The amplitude gain in the head amplifier 14 is increased when the amplitude of the FE signal/TE signal is small, while the amplitude gain in the head amplifier 14 is reduced when the amplitude of the FE signal/TE signal is large. Thereby, the FE signal/TE signal with constant amplitude is supplied to the servo control chip 15. Such control of the head amplifier 14 is performed by, for example, the microcomputer 20 for control which received the VDET signal 35.

More specifically, the amplitude (gain) of the TE signal (output a of the vibration detection filter 32) obtained via the vibration detection filter 32 is compared to the threshold output b in the operational amplifier 36, and the gain (amplitude) control is realized based on a result of the comparison. As a result, the variation difference resulting from the optical disc and the pickup are reduced.

Even in the conventional cases where it was sometimes not possible to detect the disc with the eccentricity irrespective of the eccentric disc because of a small value of the amplitude due to variation of the amplitude of the TE signal, the detection failure, however, can be avoided when the FE signal/TE signal whose amplitude is substantially at a certain level is supplied to the servo control chip 15 and the amplitude is thereafter adjusted to be at the certain level. Thereby, the eccentric disc can be discriminated from any other disc. As a result, the compatibility of reproducing the scratch disc and the eccentric disc, which are equal to those of the three-motor optical disc device, can be realized in the two-motor optical disc device, and the disc reproduction capacity can be improved while the further cost reduction is achieved.

Another modified embodiment of the present preferred embodiment is described below. FIG. 5 is a characteristic diagram showing the VDET signal during execution of the eccentricity detection according to the present modified embodiment. 35 denotes a VDET signal whose level turns to “High” in synchronization with a timing of the eccentricity detection. 52 denotes a timing of starting the eccentricity detection measurement of the VDET signal 35. 53 denotes a timing of ending the eccentricity detection measurement of the VDET signal 51. 54 denotes a period of the eccentricity detection measurement.

When the optical disc 11 is rotated at the normal speed, the rotation speed in the inner peripheral part of the optical disc 11 is approximately 8 Hz as described earlier. In the VDET signal 35 generated when the optical disc 11 under generation of the eccentricity is rotated, the “High” level is detected at a frequency (8 Hz) interval equal to the rotation frequency of the optical disc 11. When the “High” level is detected at any other frequency interval in the VDET signal 35, it can be judged that the optical disc 11 is not eccentric. In order to further prevent the misjudgment based on the foregoing viewpoint, number of times of the “High” level (frequency) that is generated in the VDETs signal 35 in accordance with the eccentricity is measured in the present preferred embodiment. The measurement of the frequency can be carried out, for example, as mentioned below.

The eccentricity detection measurement period 54 is measured by the count of the microcomputer 20 for control. During the measurement, how many times the “High” level of the VDET signal 35 is detected is measured. Then, the measured number of the “High” level detections is divided by the eccentricity detection measurement period 54 so that the number of the “High” level detections per unit time is calculated. When the measured number of the “High” level detections per unit time is substantially equal to the rotation number (8 Hz or the like) of the optical disc, the optical disc is judged to be eccentric. The eccentric disc can be more accurately detected by implementing the present modified embodiments

Though the preferred embodiments of this invention are explained in detail, it will be understood that various modifications may be made therein, and it is intended to cover in the appended claims all such modifications as fall within the true spirit and scope of this invention.

What is claimed is:

1. A method of controlling an optical disc device having a vibration detector for detecting vibrations generated in an optical disc device, comprising:
a setting step in which a detected vibration band of the vibration detector is set to a band capable of selectively detecting the vibrations generated in the optical disc device in the case where an optical disc mounted in the optical disc device so as to be rotated and driven has eccentricity; and
a judging step in which the detected vibration band is set in the setting step, the vibration is detected by the vibration detector in the state where the optical disc is rotated and driven in the optical disc device, and it is judged that the optical disc in the rotating state is eccentric when the vibration is detected.

2. The method of controlling the optical disc device according to claim 1, wherein
the setting step and the judging step are implemented every time when the optical disc is mounted in the optical disc device.

3. The method of controlling the optical disc device according to claim 1, further comprising a step in which a servo constant used when a recording/reproduction position of the optical disc is controlled is changed into a servo constant for the eccentric disc when it is judged that the optical disc in the rotating state is eccentric in the judging step.

4. The method of controlling the optical disc device according to claim 1, wherein
a vibration detector having a filter for selectively allowing passage of a frequency component superposed on a recording/reproduction position control signal of the optical disc device by the vibrations is used as the vibration detector.

5. The method of controlling the optical disc device according to claim 4, wherein
a digital filter capable of switching to each other a first filter characteristic which selectively allows the passage of the frequency component superposed on the recording/reproduction position control signal in the state where the vibration is generated in the optical disc device and a second filter characteristic which selectively allows the passage of the frequency component superposed on the recording/reproduction position control signal in the state where the eccentric optical disc is rotated is used as the filter, wherein
a filter characteristic of the digital filter is changed from the first filter characteristic to the second filter characteristic in the setting step.

6. The method of controlling the optical disc device according to claim 4, wherein
a tracking error signal is used as the recording/reproduction position control signal.

7. The method of controlling the optical disc device according to claim 1, wherein
a driving rotation number of the optical disc by the optical disc device is used as a frequency of the vibrations generated when the optical disc is eccentric in the setting step.

8. The method of controlling the optical disc device according to claim 4, wherein
the vibration is detected by the vibration detector in a state where an amplitude gain of the recording/reproduction position control signal is adjusted so that variation difference resulting from the optical disc and a pickup are reduced in the judging step.

9. The method of controlling the optical disc device according to claim 4, wherein
the judging step is executed when TOC is read, and
number of times of the frequency component output from the filter is measured, and the optical disc in the rotating state is judged to be eccentric in the case where the output number is at least a predetermined number in the judging step.

10. The method of controlling the optical disc device according to claim 9, wherein
a time length of a period when the TOC is read is measured, the number of times of the frequency component output from the filter during the TOC reading period is measured, and the output number is divided by the time length of the TOC reading period so that the output number per unit time is calculated, and it is judged that the optical disc in the rotating state is eccentric when the calculated output number per unit time is approximate to the rotation number of the optical disc in the optical disc device in the judging step.

11. An optical disc device comprising:
a spindle motor for rotating an optical disc retained on a disc tray;
a pickup for recording and reproducing data of the rotated optical disc;
a head amplifier for amplifying an output of the pickup and generating a tracking error signal based on the output of the pickup;
a servo controller for executing an operation of servo based on the tracking error signal;
a driver for moving the pickup to a targeted point of the optical disc based on a result of the operation by the servo controller; and
a controller for controlling these components, wherein
the servo controller comprises a vibration detector,
the vibration detector comprises a digital filter capable of switching to each other a first filter characteristic which selectively allows passage of a frequency component superposed on the tracking error signal when vibration is generated and a second filter characteristic which selectively allows the passage of the frequency component superposed on the tracking error signal when the optical disc having eccentricity is rotated,
the controller sets a filter characteristic of the digital filter to the first filter characteristic when the vibration is generated and sets the filter characteristic to the second filter characteristic when the eccentricity of the optical disc is detected, and
the vibration detector detects the vibrations in the device or the eccentricity of the disc based on presence or absence of the passed output from the digital filter.

12. The optical disc device according to claim 11, wherein
the controller makes the vibration detector detect presence or absence of the eccentricity of the optical disc every time when the optical disc is mounted in the optical disc device.

13. The optical disc device according to claim 11, wherein
the optical disc device further comprises a motor for reciprocating the disc tray between a recording/reproduction position and a disc removal position and moving the pickup along a radial direction of the optical disc based on the control by the driver, and
the controller sets a servo constant of the servo controller to a servo constant for the eccentric disc when the vibration detector detects the eccentricity of the optical disc, and sets the servo constant to a servo constant for the non-eccentric disc otherwise.

14. The optical disc device according to claim 11, wherein
the controller makes the vibration detector detect the vibrations in a state where an amplitude gain of the recording/reproduction position control signal is adjusted so that variation difference resulting from the optical disc and a pickup are reduced.

15. The optical disc device according to claim 11, wherein
the vibration detector detects the eccentricity of the disc when TOC is read, and
the vibration detector measures number of times when the frequency component is outputted from the filter, and judges that the optical disc in the rotating state is eccentric in the case where the output number is at least a predetermined number.

16. The optical disc device according to claim 15, wherein
the vibration detector measures a time length of a period when the TOC is read, and at the same time measures the number of times of the frequency component output from the digital filter during the TOC reading period, and divides the output number by the time length of the TOC reading period so that the out
put number per unit time is calculated, and
the vibration detector judges that the optical disc in the rotating state is eccentric when the calculated output number per unit time is approximate to the rotation number of the optical disc in the optical disc device.
